(19) United States
(12) Patent Application Publication
(10) Pub. No.: US 2017/0054228 A1
(43) Pub. Date: Feb. 23, 2017

(54) QUICK CLAMPING TYPE CABLE CONNECTOR

(71) Applicant: Yousong XIAO, Shenzhen (CN)

(72) Inventors: Yousong XIAO, Shenzhen (CN); Mengjun NING, Shenzhen (CN); Liangjia CHENG, Shenzhen (CN)

(21) Appl. No.: 15/307,292

(22) PCT Filed: May 19, 2014
(86) PCT No.: PCT/CN2014/077773

§ 371 Date: Oct. 27, 2016

(51) Int. Cl. H01R 4/50; H01R 11/12

(52) U.S. Cl. CPC H01R 4/5083; H01R 11/12

(57) ABSTRACT

A quick clamping type cable connector comprises a cable clamping body (1), one end of the cable clamping body (1) is provided with a cable clamping retaining member (12), the other end of the cable clamping body (1) is provided with a cable clamping block (14), and a cable clamping slider (16) capable of wedged sliding along the outside of the cable clamping block (14) is arranged in a manner of cooperation with the cable clamping block (14); a cable is clamped by means of wedged sliding between the cable clamping slider (16) and the cable clamping block (14); due to the capability of connection with different types of retaining members according to different requirements, the cable clamping retaining member (12) is applicable for cables of different shapes, and therefore there is a wide range of application; a plurality of protrusions for reinforcing clamping are arranged in the cable clamping slider (16), thus the clamping force acting upon the cable can be ensured; clamping can be realized only by sliding between the cable clamping slider (16) and the cable clamping block (14) without positioning and additional fixation, thus the quick clamping type cable connector is simple to use and high in efficiency.

### FIELD OF THE UTILITY MODEL

The present utility model relates to a power device auxiliary appliance, and in particular, relates to quick clamping fixing of a cable.

### BACKGROUND OF THE UTILITY MODEL

Generally, a cable is thicker and made of metal, so a special fixing clamp is used when the cable is straightened and one end of the cable is fixed; at present, a common cable fixing clamp generally comprises a static chuck and a moving chuck, for example a cable connecting clamp disclosed in the document of patent CN201210577029.7, which aims to realize the clamping of the cable and realize conductive communication, the connecting clamp is complex in structure and comprises first and second moving clamps, aligning is required in the clamping process, the connecting is realized by bolts, the clamping time is longer, the working efficiency is low and the connecting clamp easily fails after used for long term due to the use of bolts; and certain regulation is required for different cables and an applicable range is not wide.

### SUMMARY OF THE UTILITY MODEL

An objective of the present utility model is to overcome the defects of the prior art and provide a quick clamping type cable connector which is capable of quickly clamping, simple and reliable in clamping manner and wide in applicable range. For realizing the above objective, the present utility model adopts the following technical solution:

the quick clamping type cable connector comprises a cable clamping body, one end of the cable clamping body is provided with a cable clamping retaining member, the other end of the cable clamping body is provided with a cable clamping block, and a cable clamping slider capable of wedged sliding along the outside of the cable clamping block is arranged in a manner of cooperation with the cable clamping block.

The section of the cable clamping block is V-shaped and comprises a cable clamping block top and two cable clamping block side walls formed by extending from the top to two sides, the section of the cable clamping block side walls is a trapezoid and ends close to the cable clamping retaining member are short sides of the trapezoid.

The section of the cable clamping block is W-shaped and comprises two cable clamping block tops in parallel and two cable clamping block side walls formed by extending from the outmost sides of the two tops to two sides, and the section of the cable clamping block side walls is a trapezoid.

The cable clamping slider comprises a slider top and slider side walls formed by extending from the slider top to two sides and cooperated with the cable clamping block side walls, the section of the slider side walls is a trapezoid, and the tail ends of the side walls are provided with bending sections for hooking the tail ends of the cable clamping block.

A plurality of inward convex bosses are disposed on the inner wall of the slider side walls contacting with the cable clamping side walls.

The cable clamping retaining member is provided one mounting through hole, and the mounting through hole is internally provided with a U-shaped aluminum pipe connected to a rubber-coated steel rope.

The cable clamping retaining member is provided two mounting through holes, and the two mounting through holes are respectively connected to two ends of a stainless steel wire in a clamping manner.

Through the above technical solution, the present utility model has the following beneficial effects:

1. Since a cable is clamped by means of wedged sliding between the cable clamping slider and the cable clamping block and different types of retaining members can be connected according to different requirements, the cable clamping retaining member is applicable for cables of different shapes, and therefore there is a wide range of application.

2. A plurality of protrusions for reinforcing clamping are arranged in the cable clamping slider, thus the clamping force acting upon the cable can be ensured;

3. Clamping can be realized only by sliding between the cable clamping slider and the cable clamping block, thus the quick clamping type cable connector is simple to use and high in efficiency.

### BRIEF DESCRIPTION OF THE DRAWINGS

FIG. 1 is a three-dimensional schematic diagram of a quick clamping type cable connector of the present utility model;

FIG. 2 is a structural front view of the quick clamping type cable connector of the present utility model;

FIG. 3 is a side view of the quick clamping type cable connector of the present utility model;

FIG. 4 is a sectional view of a cable clamping slider of the quick clamping type cable connector of the present utility model.

### DETAILED DESCRIPTION OF THE INVENTION

The present utility model is further explained in detail in combination with the drawings.

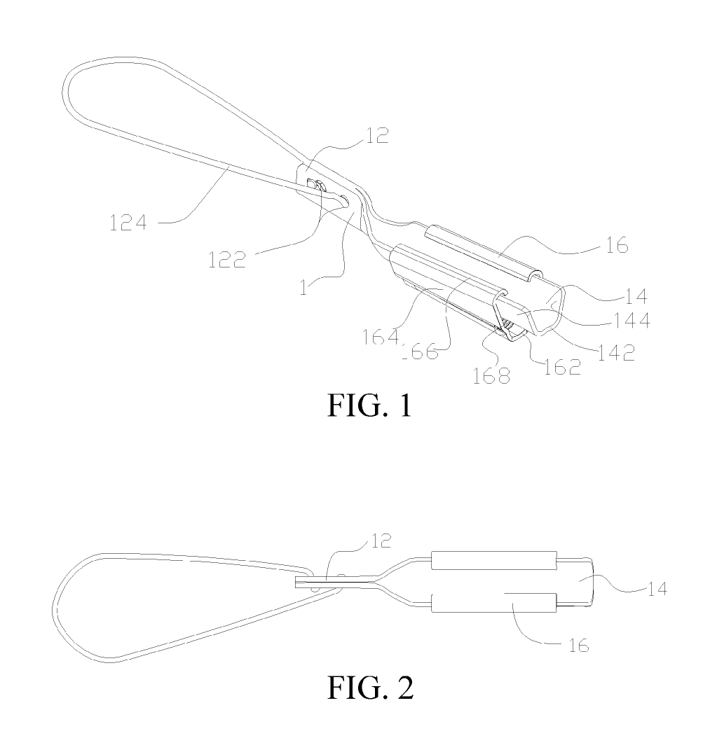

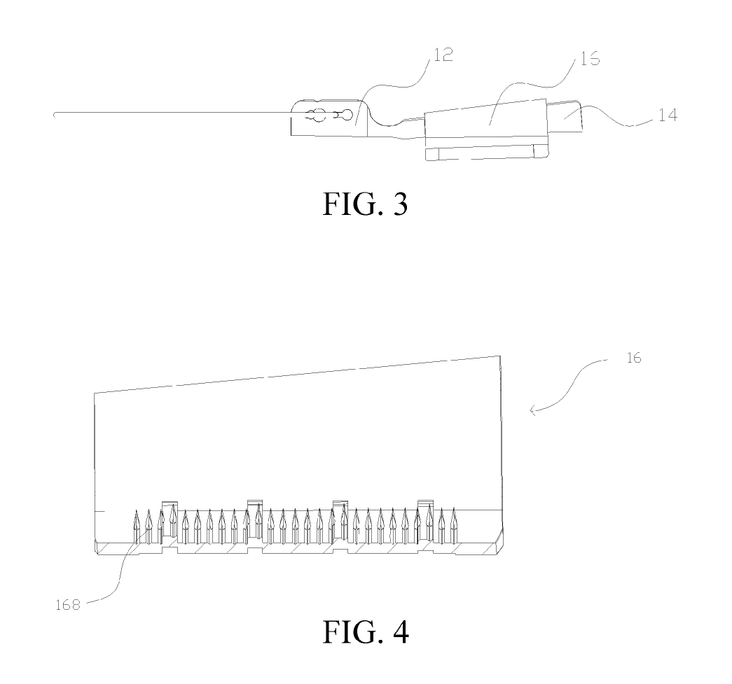

As shown in FIGS. 1-4, the quick clamping type cable connector comprises a cable clamping body 1, one end of the cable clamping body is provided with a cable clamping retaining member 12, the other end of the cable clamping body is provided with a cable clamping block 14, and a cable clamping slider 16 capable of wedged sliding along the outside of the cable clamping block is arranged in a manner of cooperation with the cable clamping block; specifically, the section of the cable clamping block 14 is V-shaped and comprises a cable clamping block top 142 and two cable clamping block side walls 144 formed by extending from the top to two sides, the section of the cable clamping block side walls is a trapezoid and ends close to the cable clamping retaining member are short sides of the trapezoid; the cable clamping slider 16 comprises a slider top 162 and slider side walls 164 formed by extending from the slider top to two sides and cooperated with the cable clamping block side walls, the section of the slider side walls is a trapezoid, and the tail ends of the side walls are provided with bending sections 166 for hooking the tail ends of the cable clamping block; in addition, a plurality of inward convex bosses 168 are disposed on the inner wall of the slider side walls contacting with the cable clamping side walls and have different heights; the cable clamping retaining member 12 is provided two mounting through holes 122, and the two mounting through holes are respectively connected to two ends of a stainless steel wire 124 in a clamping manner.

When in use, one end of the cable clamping retaining member 12 is retained, then a cable to be connected is plugged into a gap between the cable clamping block 14 and the cable clamping slider 16, then the cable clamping slider 16 is pushed to move to the direction of the cable clamping retaining member, in the moving process, since the cable is made of aluminum generally, the bosses can be tightly clamped into the surface of the cable and form occlusion, and the retaining is realized when an external force cannot push the clamped cable to slide any more.

Compared with the prior art, since a cable is clamped by means of wedged sliding between the cable clamping slider, and meanwhile, the cable clamping block and different types of retaining members can be connected according to different requirements, the cable clamping retaining member is applicable for cables of different shapes, and therefore there is a wide range of application; a plurality of protrusions for reinforcing clamping are arranged in the cable clamping slider, thus the clamping force acting upon the cable can be ensured; clamping can be realized only by sliding between the cable clamping slider and the cable clamping block without positioning and additional fixation, thus the quick clamping type cable connector is simple to use and high in efficiency.

Of course, the section of the cable clamping block is W-shaped and comprises two cable clamping block tops in parallel and two cable clamping block side walls formed by extending from the outmost sides of the two tops to two sides, and the section of the cable clamping block side walls is a trapezoid, in this way, two cables can be clamped at one step or according to different pull force requirements, the cable clamping retaining member is provided one mounting through hole, and the mounting through hole is internally provided with a U-shaped aluminum pipe connected to a rubber-coated steel rope, which should belong to a protection scope of the present utility model.

1. A quick clamping type cable connector comprising a cable clamping body, characterized in that one end of the cable clamping body is provided with a cable clamping retaining member, the other end of the cable clamping body is provided with a cable clamping block, and a cable clamping slider capable of wedged sliding along the outside of the cable clamping block is arranged in a manner of cooperation with the cable clamping block.

2. The quick clamping type cable connector according to claim 1, characterized in that the section of the cable clamping block is V-shaped and comprises a cable clamping block top and two cable clamping block side walls formed by extending from the top to two sides, the section of the cable clamping block side walls is a trapezoid and ends close to the cable clamping retaining member are short sides of the trapezoid.

3. The quick clamping type cable connector according to claim 1, characterized in that the section of the cable clamping block is W-shaped and comprises two cable clamping block tops in parallel and two cable clamping block side walls formed by extending from the outmost sides of the two tops to two sides, and the section of the cable clamping block side walls is a trapezoid.

4. The quick clamping type cable connector according to claim 2, characterized in that the cable clamping slider comprises a slider top and slider side walls formed by extending from the slider top to two sides and cooperated with the cable clamping block side walls, the section of the slider side walls is a trapezoid, and the tail ends of the side walls are provided with bending sections for hooking the tail ends of the cable clamping block.

5. The quick clamping type cable connector according to claim 4, characterized in that a plurality of inward convex bosses are disposed on the inner wall of the slider side walls contacting with the cable clamping side walls.

6. The quick clamping type cable connector according to claim 5, characterized in that the cable clamping retaining member is provided one mounting through hole, and the mounting through hole is internally provided with a U-shaped aluminum pipe connected to a rubber-coated steel rope.

7. The quick clamping type cable connector according to claim 5, characterized in that the cable clamping retaining member is provided two mounting through holes, and the two mounting through holes are respectively connected to two ends of a stainless steel wire in a clamping manner.
